(19) United States
(12) Patent Application Publication
(10) Pub. No.: US 2013/0048090 A1
(43) Pub. Date: Feb. 28, 2013

(54) HUMAN BODY SENSITIVE TOUCH-CONTROLLED WATER OUTLET DEVICE AND CONTROL METHOD THEREOF

(71) Applicant: Yuanhong Yang, Guangdon (CN)

(72) Inventor: Yuanhong Yang, Guangdon (CN)

(73) Assignees: GUANGZHOU SEAGULL KITCHEN AND BATH PRODUCTS CO., LTD., Guangdong Province (CN); GUANGZHOU NEON PLUMBING PRODUCTS CO., LTD., Guangdong Province (CN); ZHUHAI EDISON ECOTECH CORPORATION CO., LTD., Guangdong Province (CN); ZHUHAI BOW KITCHEN & BATH PRODUCTS CO., LTD., Guangdong Province (CN); ZHUHAI SEAGULL KITCHEN AND BATH PRODUCTS CO., LTD., Guangdong Province (CN)

(21) Appl. No.: 13/695,406

(22) PCT Filed: Oct. 26, 2011
(86) PCT No.: PCT/CN11/01789

§ 371 Date: Oct. 30, 2012

(30) Foreign Application Priority Data
Jan. 30, 2011 (CN) 201110032791.2

(51) Int. Cl. F16K 21/00

(52) U.S. Cl. 137/1; 137/801

(57) ABSTRACT

A human body sensitive, touch-controlled water outlet device includes: a faucet body, a cold water inlet, a hot water inlet and a switch unit, with the switch unit including a touch sensitive module, a control module and a power source module. When a human body touches the switch control sensing zone or the water temperature switchover zone arranged on the faucet body, the touch sensitive module identifies the touch signal and outputs a corresponding sensed signal to the control module, and then the control module controls the water outlet device according to the sensed signal, so as to open or close the water outlet device and provide the selected type of outlet water. Further disclosed is a method for controlling the human body sensitive, touch-controlled water outlet device. The human body sensitive, touch-controlled water outlet device is convenient to use and has a high touch control precision.

### FIELD OF THE INVENTION

The present invention relates to a device for supplying water, in particularly relates to a body induction touch control faucet device.

### DESCRIPTION OF THE RELATED ART

A faucet is a device for supplying water which is commonly used in daily life. Currently, most of commercial available faucets are controlled through traditional manual mechanical methods, and can be adjusted manually while being used. It is not only inconvenient for users, but also prone to bringing physical deterioration, so that it may cause problems such as lack of flexibility of the faucet and water leakage. Therefore, induction faucets emerged. Usually, the induction faucet disclosed in the existing technology may comprise infrared induction faucets. However, the infrared induction faucet may be limited by controlling angle, which means if the valve of the angle is larger than that of an induction angle, the induction faucet may fail to supply water, which brings about inconvenience, furthermore, another problem of the infrared induction faucet is time delay, i.e. supplying water may be delayed for a while when user's hand may be inducted, and when user's hand leaves the induction zone, closing the induction faucet may also be delayed for a while, which causes waste of water.

In order to solve the above problems, China patent literature with publication. No. CN201627971U discloses a body induction touch control faucet, comprising an inlet unit, a faucet body and a switch unit. The faucet body is made of metal and the switch unit may comprise a signal processing module, a preset signal comparing module, a controller and an electromagnetic valve. The signal processing module may comprise an input terminal and an output terminal, and the output terminal is in connection with the faucet body through signal line; the comparing module is in connection with the output terminal of the signal processing module; the controller is in connection with the comparing module; the electromagnetic valve is in connection with the controller and the electromagnetic valve may be arranged between the inlet unit and the faucet body.

It is disclosed in this patent literature that the entire faucet body may be configured as a touch sensing zone, which may receive induction signal through the signal processing module and the comparing module arranged on a circuit board, so as to open or close the faucet through touch control. However, since the entire faucet body may be configured as a touch sensing zone, its switch may be activated even if people touch the faucet body unintentionally while they are washing hands, which may cause mis-operation. Furthermore, because an induction signal may be obtained through filtering and amplifying by the signal processing module as well as being compared by the comparing module, which may be easily affected by ambient humidity and external signals, identification of induction signal may be affected. In addition, it was disclosed in this patent literature that adjustment of water temperature is controlled by mechanical valve, which may cause problems such as mechanical wear and low usability, and adjustment of water temperature may only be adjusted gradually instead of direct switch among hot water, cold water and warm water. It may waste water during adjustment and may not provide lots of choices of types of water to be supplied.

### SUMMARY OF THE INVENTION

In view of the above-described problems, one of the objectives of this invention is to provide a body induction touch control faucet device with specific sensing zones and high accuracy for touch sensing, in order to solve problems of touch sensing faucet device of prior art, such as touch sensing zone prone to being operated by mistake, or touch signals affected by external environment easily.

Another objective of this invention to provide a body induction touch control faucet device with a function of switching among cold water, warm water and hot water, so as to solve the problems of touch sensing faucet device with a mechanical valve adjusting water temperature of prior art, such as mechanical wear, incontinent for using and limited for adjusting.

To achieve the above mentioned objectives, in accordance with one embodiment of this invention, there is provided a body induction touch control faucet device, comprising

a faucet body, provided with an outlet,
a cold water inlet pipe,
a hot water inlet pipe and
a switch unit;
wherein, the cold water inlet pipe and the hot water inlet pipe are in connection with the faucet body through a mixing valve, and the cold water inlet pipe and the hot water inlet pipe are in connection with an inlet of the mixing valve through water inlet electromagnetic valves thereof respectively, and the faucet body is in connection with an outlet of the mixing valve, the faucet device further comprises a sensing zone for switch control and a sensing zone for water temperature switching, arranged on the faucet body, adapted for being touched; and
the switch unit comprises a touch sensing module, which is in connection with the sensing zone for switch control and the sensing zone for water temperature switching respectively, for detecting a touch signal from the sensing zone for switch control and the sensing zone for water temperature switching, and for outputting an induction signal corresponding to a touch behaviour after processing the touch signal;
a control module, in connection the touch sensing module, adapted to receive the induction signal outputted by the touch sensing module, and to activate the cold water inlet electromagnetic valve and the hot water inlet electromagnetic valve; and
a power module, for supplying power for the touch sensing module and the control module.

In a class of this embodiment, the faucet device further comprises a plurality of water temperature indicating devices, mounted on the faucet body and in connection with the control module;

and the control module may activate a corresponding water temperature indicating device according to the type of water selected through an induction signal.

In a class of this embodiment, the faucet device further comprises

a voltage detecting module, in connection with the power module, adapted for detecting voltage of the power module; and
a lower voltage alarming device, arranged on the faucet body and in connection with the voltage detecting module;
if voltage detected by the voltage detecting module is lower than alarm voltage, the lower voltage alarming device may give an alarm.

In a class of this embodiment, the faucet body may be made of metal and may be mounted on a faucet base, which comprises a left hollow tube, a right hollow tube and a water outlet tube; the left hollow tube may be the sensing zone for water temperature switching, and the right hollow tube may be the sensing zone for switch control; a lower end of the left hollow tube a lower end of the right hollow tube may be connected with each other through an insulating member, and be further connected with an outlet of the mixing valve through a connecting pipe; an upper end of the left hollow tube and a upper end of the right hollow tube are in connection with the water outlet tube having outlets through an insulating member respectively.

In a class of this embodiment, the faucet device further comprises

a delay selection switch, in connection with the control module and adapted for setting outflow time of the faucet body for supplying water.

In a class of this embodiment, the touch sensing module may comprise a human body touch sensing chip.

To achieve the above mentioned objectives, in accordance with one embodiment of this invention, there is provided a method for controlling the faucet device of this invention, comprising steps of:

step 1: when the faucet device is in its closed state and a sensing zone for switch control is touched by a human body, a touch sensing module may detect a touch signal and output an induction signal for supplying water to a control module after processing such touch signal, and the control module may open a water inlet electromagnetic valve after receiving the induction signal for supplying water; and then, water flows into the faucet body through the mixing valve and flows out through the outlet of the faucet body;
step 2: when a sensing zone for water temperature switching is touched by a human body, the touch sensing module may detect a touch signal and select the type of water to be supplied based on preset times of touching correspondingly, and output an induction signal related to a type of water after processing such touch signal; the control module may select and open corresponding water inlet electromagnetic valve to supply water based on the type of water selected after receiving the induction signal related to a type of water;
step 3: when the sensing zone for switch control is touched again by a human body, the touch sensing module may detect a touch signal and process the same into an induction signal for stopping water supply, and then transmit the induction signal for stopping water supply to the control module; the control module may close the inlet control valve that is in its open state after receiving the induction signal for stopping water supply, in order to stop supplying water.

To achieve the above mentioned objectives, in accordance with one embodiment of this invention, there is provided a method for controlling the faucet device of this invention, comprising steps of:

step 1: when the faucet device is in its closed state and a sensing zone for water temperature switching is touched by a human body, a touch sensing module may detect a touch signal and output an induction signal related to a type of water based on preset times of touching correspondingly after processing such touch signal; a control module may select corresponding water inlet electromagnetic valve after receiving the induction signal for supplying water;
step 2: when the sensing zone for switch control is touched by a human body, the touch sensing module may detect a touch signal and output an induction signal for supplying water to a control module; after receiving the induction signal for supplying water, the control module may open the inlet electromagnetic valve selected, so as to let water flow into the faucet body through the mixing valve and flow out through the outlet of the faucet body;
step 3: when the sensing zone for switch control is touched again by a human body, the touch sensing module may detect a touch signal and output an induction signal for stopping water supply to the control module after processing such touch signal; after receiving the induction signal for stopping water supply, the control module may close the inlet control valve that is in its open state, so as to stop supplying water through the outlet of the faucet body.

In a class of this embodiment, the type of water may be cold water, warm water or hot water; cold water may be selected if the sensing zone is touched once, warm water may be selected if the sensing zone is touched twice, and hot water may be selected if the sensing zone is touched three times; but it does not work if the sensing zone is touched more than three times;

when the sensing zone for water temperature switching is touched by a human body once, the touch sensing module may detect a touch signal and output an induction signal related to cold water after processing such touch signal; the control module may receive such induction signal related to cold water and open a cold water inlet electromagnetic valve instead of a hot water inlet electromagnetic valve;
when the sensing zone for water temperature switching is touched twice by a human body, the touch sensing module may detect a torch signal and output an induction signal related to warm water after processing; the control module may receive such induction signal related to warm water and open both of the cold water inlet electromagnetic valve and the hot water inlet electromagnetic valve;
when the sensing zone for water temperature switching is touched three times by a human body, the touch sensing module may detect a touch signal and output an induction signal related to hot water after processing such touch signal; the control module may receive such induction signal related to hot water and open the hot water inlet electromagnetic valve instead of the cold water inlet electromagnetic valve.

In a class of this embodiment, after receiving the induction signal related to a type of water, the control module may activate a water temperature indicating device corresponding to the type of water.

In a class of this embodiment, the control module may comprise memory function, adapted for recording the information about the type of water which is selected through the sensing zone for water temperature switching, which allows to supply water with the type recorded for the last use when the sensing zone for switch control is touched neat time.

In a class of this embodiment, the touch sensing module may comprise key-locking and unlocking functions, when key-locking function is activated, any touching on the sensing zone for switch control or the sensing zone for water temperature switching does not work.

Advantages of this invention are summarized below:

1. The body induction touch control faucet device of this invention comprises a faucet body provided with an outlet, a cold water inlet pipe, a hot water inlet pipe and a switch unit comprising a touch sensing module, a control module and a power module, and wherein, when the sensing zone for switch control or sensing zone for water temperature switching arranged on the faucet body is touched by a human body, the induction signal may be identified by the touch sensing module, and corresponding induction signal may be outputted to the control module, which may open and close the faucet device in terms of selected type of water to be supplied based on the induction signal, in addition, the faucet device may be opened and closed by touching a specific zone, so as to avoid mis-operation if the entire faucet body is configured as a touching induction zone and thus save water. Furthermore, the type of water to be supplied may be selected by touching the specific zone, and the type of water to be supplied may be set in terms of temperature of water, such as hot water, cold water and warm water, and also may be set in terms of other factors based on user's needs. Therefore, the type of water to be supplied may be selected by touching, which may solve the above-mentioned problems of the prior art, so the faucet de-ice of this invention may have advantages such as ease of use, high touching accuracy and intelligence.
2. It is advantageous for the faucet device of this invention, to further comprise a plurality of water temperature indicating devices, such as indicator lamps, which may give an indication corresponding to the type of water to be supplied, because it may indicate the type of water to be supplied to users, so as to facilitate the use and switching of the faucet device.
3. It is advantageous for the faucet device of this invention, to further comprise a lower power alarming device which may give an alarm when voltage of the power module is lower than the threshold for alarming, because it can remind the users to change the power module to guarantee daily use.
4. It is advantageous for the faucet device of this invention to further comprise a metallic faucet body, a left hollow tube, a right hollow tube and an outlet tube, all of which may be in connection with each other through an insulating member, wherein the left hollow tube is configured as a sensing zone for water temperature switching, the right hollow tube is configured as a sensing zone for switch control and an outlet may be arranged on the outlet tube, because it allows the sensing zone to be easily set up, and will not allow signals from both of the sensing zone to be mixed up, which improves touching accuracy and the design of the faucet device.
5. It is advantageous for the faucet device of this invention to further comprise a delay selection switch which may be in connection with the control module and be adapted for setting outflow time at which water begins to flow out of the faucet body, because it allows users to set outflow time and also allows the faucet device to be automatically closed when the time is up, without any need of touching the sensing zone again, and this may be very convenient for users.
6. It is advantageous for the touch sensing module of the faucet device of this invention to further comprise a body touch sensing chip, because a body touch sensing chip may help to improve touch sensing performance of the faucet device, and comparing to the identifying unit with simple circuit of the prior arts, the faucet device of this invention may be much more capable of identifying and anti-jamming.
7. It is advantageous for the method for controlling a faucet device of this invention, to comprises steps of: step 1: when the faucet device is in its closed state and a sensing zone for switch control is touched by a human body, a touch sensing module may detect a touch signal and a control module may execute a control instruction and open the electromagnetic valve; step 2: when a sensing zone for water temperature switching is touched by a human body, the touch sensing module may detect a touch signal and select the type of water to be supplied based on pre-set times of touching correspondingly and the control module may execute a control instruction to select and open corresponding water inlet electromagnetic valve to supply water so that water may be supplied based on user's selection, because the method may allow water to be supplied very easily and may also meet the needs for different types of water to be supplied.
8. It is advantageous for the method for controlling a faucet device of this invention, to comprise the steps of selecting the type of water to be supplied with touching the sensing zone for water temperature switching, and then opening the outlet device with touching the sensing zone for switch control, because it may allow users to select the type of water prior to supplying water, which may save water.
9. It is advantageous for the method for controlling a faucet device of this invention, wherein, cold water may be selected if the sensing zone is touched once, warm water may be selected if the sensing zone is touched twice, and hot water may be selected if the sensing zone is touched three times, but it does not work if the sensing zone is touched more than three times, because it may allow users to set touching times based on using condition, in order to improve the usability of device.
10. It is advantageous for the method for controlling a faucet device of this invention, to comprise the steps of recording the information about the type of water which is selected through the sensing zone for water temperature switching, because it allows to supply water with the type recorded for the last use when the sensing zone for switch control is touched next time, so that there is no need to reset the type of water to be supplied if the type of water required is the same as the type recorded for the last use, which may improve the usability and intelligence of device,
11. It is advantageous for the method of controlling a faucet of this invention, wherein, the touch sensing module may comprise key-locking and unlocking functions and when key-locking function is activated, any touching on the sensing zone for switch control or the sensing zone for water temperature switching does not work, because it allows key-locking and unlocking functions to be set up according to user's need, which may enhance the functionality of the faucet device of this invention and bring more convenience to users so as to meet the needs for different situations,

### BRIEF DESCRIPTION OF THE DRAWINGS

Detailed description will be given below hr conjunction with accompanying drawings:

FIG. 1 is a schematic diagram of a body induction touch control faucet device according to one embodiment of this invention;

FIG. 2 is an internal block diagram of a switch unit of a body induction touch control faucet device according to one embodiment of this invention;

FIG. 3 is a function block diagram of a body induction touch control faucet device according to one embodiment of this invention;

FIG. 4 is a circuit diagram of a touch sensing module of a body induction touch control faucet device according to one embodiment of this invention;

FIG. 5 is a circuit diagram of a control module of a body induction touch control faucet device according to one embodiment of this invention;

FIG. 6 is a schematic diagram of a delay selection switch of a body induction touch control faucet device according to one embodiment of this invention;

FIG. 7 is a system block diagram of a control module of a body induction touch control faucet device according to one embodiment of this invention;

FIG. 8 is a circuit diagram of a water temperature indicating device of a body induction touch control faucet device according to one embodiment of this invention;

FIG. 9 and FIG. 10 are drive circuit diagrams of an inlet electromagnetic valve of a body induction touch control faucet device according to one embodiment of this invention;

FIG. 11 is a circuit diagram of a voltage detecting module of a body induction touch control faucet device according to one embodiment of this invention;

FIG. 12 is a circuit diagram of a power module of a body induction ouch control faucet device according to one embodiment of this invention.

In the drawings, the following reference numbers are used: 100—faucet device; 130, 140, 160—insulating member; 150—water outlet tube; 110—left hollow tube; 120—right hollow tube; 200—faucet base; 310—cold water inlet pipe; 320—hot water inlet pipe; 330—connecting pipe; 400—control case; 401—upper cover; 402—lower cover; 410—mixing valve; 420—outlet of the mixing valve; 430, 440—water inlet electromagnetic valves; 450—battery; 461—upper cover of a circuit board case; 462—a lower cover of a circuit board case; 463—circuit board; 500—connecting line; 501—waterproof plug; 600—external power module.

### DETAILED DESCRIPTION OF THE EMBODIMENTS

### Example 1

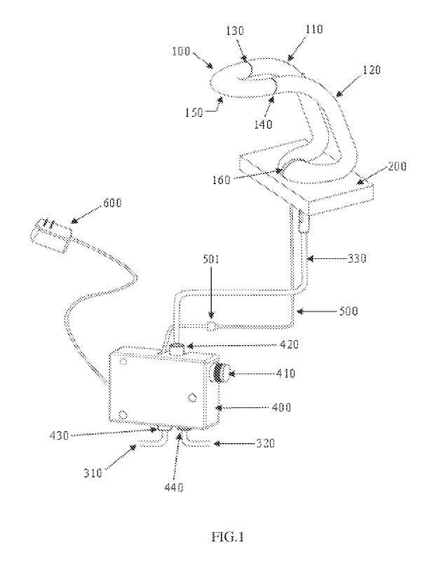

Referring to FIG. 1, one embodiment of the body induction touch control faucet device of this invention comprises a faucet body 100 provided with an outlet, a cold water inlet pipe 310, a hot water inlet pipe 320 and a switch unit. Both of the cold water inlet pipe 310 and the hot water inlet pipe 320 are in connection with the faucet body 110 through a mixing valve 410, and the cold water inlet pipe 310 and the hot water inlet pipe 320 are in connection with an inlet of the mixing valve 410 through water inlet electromagnetic valves 430, 440 thereof respectively, and the faucet body 100 is in connection with an outlet 420 of the mixing valve, and the faucet body 100 is provided with a touch sensing zone for switch control and another sensing zone for water temperature switching.

The switch unit comprises:

a touch sensing module, which is in connection with the touch sensing zone for switch control and the sensing zone for water temperature switching respectively, for detecting and processing touch signal of the touch sensing zone for switch control and the sensing zone for water temperature switching to output an induction signal corresponding with touching activity;
a control module, in connection with the touch sensing module, adapted to receive the induction signal output by the touch sensing module, and to activate the cold water inlet electromagnetic valve 430 and the hot water inlet electromagnetic valve 440 in terms of the induction signal;
a power module, for supplying power for the touch sensing module and the control module.

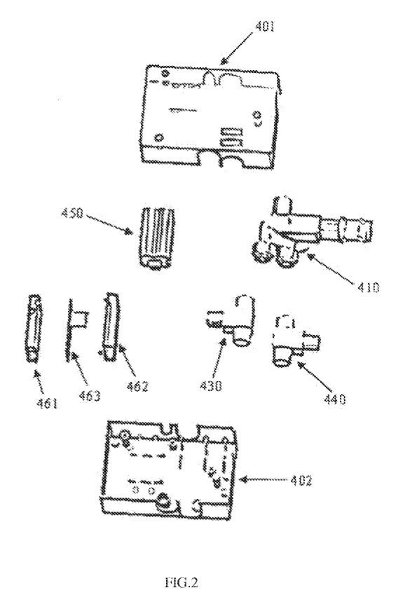

In this embodiment, the faucet body 100 may be made of metal and may be mounted on a faucet base 200, which comprises a left hollow tube 110, a right hollow tube 120 and a water outlet tube 150. Furthermore, the left hollow tube 110 may be the sensing zone for water temperature switching, and the right hollow tube 120 may be the touch sensing zone for switch control; a lower end of the left hollow tube 110 sensing and a lower end of the right hollow tube 120 are connected with each other through an insulating member 160, and the lower ends are in connection with the outlet 420 of the mixing valve through a connecting pipe 330; the water outlet tube 150 is connected to the top areas of the left hollow tube 110 and the right hollow tube 120 through insulating members 130, 140 respectively; in this embodiment, the switch unit, the mixing valve 410 and the water inlet electromagnetic valves 430, 440 are all arranged inside the control case 400; FIG. 2 shows that the control case 400 comprises a upper cover 401 and a lower cover 402, and the switch unit is arranged on a circuit board 463 and enclosed by a upper cover 461 and a lower cover 462 of a circuit board case; a battery 450 is arranged inside the control case 400 for supplying power for the circuit board 463, meanwhile the power of the circuit board 463 may also be supplied by an external power module 600; FIG. 12 shows the principle of power supplying for the circuit board; the touch sensing module of the switch unit may be a body touch sensing chip, such as Holtek BS802B with high performance and the control module may be Sonic SCM SN8P2612S.

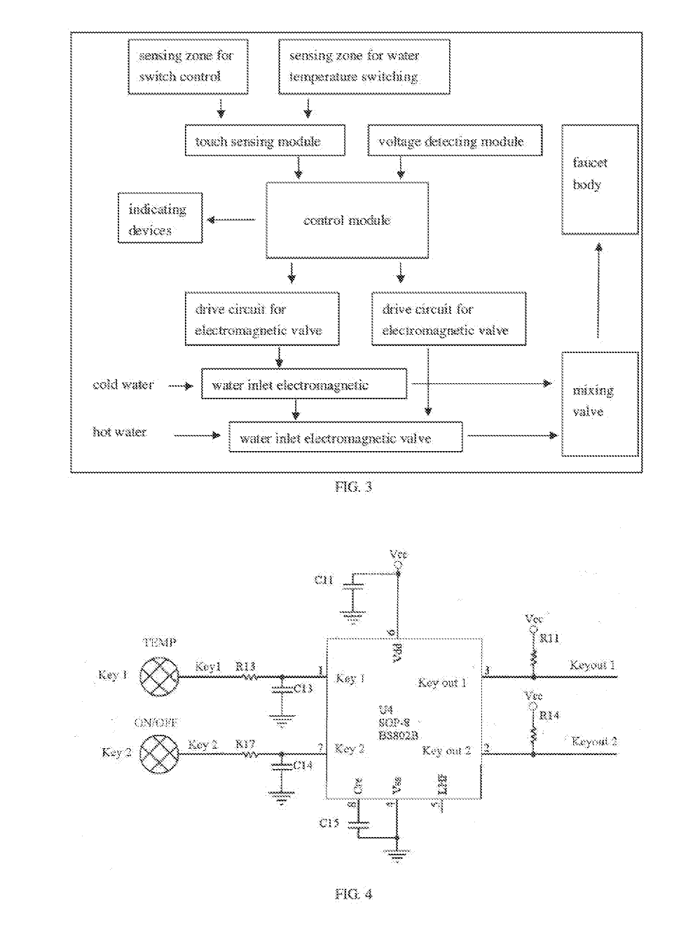

FIG. 3 shows a function block diagram for the body induction touch control faucet device, in this embodiment, a control method is disclosed, wherein

when the body induction touch control faucet device is in its closed state, the touch sensing module may detect a touch signal if the touch sensing zone for switch control is touched by a human body; after processing the touch signal, the touch sensing module may output an induction signal for supplying water to the control module, and the control module may control to open the water inlet electromagnetic valve after receiving the induction signal for supplying water; and then, water may flow into the faucet body through the mixing valve and flows out through the outlet of the faucet body;
when the sensing zone for water temperature switching is touched by a human body, the touch sensing module may detect a touch signal and select a type of water based on corresponding preset times of touching, and then may accordingly output an induction signal related to a type of water outflow type; the type of water may be cold water, warm water or hot water, and cold water may be selected if the sensing zone is touched once, warm water may be selected if the sensing zone is touched twice, and hot water may be selected if the sensing zone is touched three times;
however, it does not work if the sensing zone is touched more than three times;
when the sensing zone for water temperature switching is touched once by a human body, the touch sensing module may detect a touch signal and output an induction signal related to cold water after processing such touch signal; the control module may open the cold water inlet electromagnetic valve instead of hot water inlet electromagnetic valve after receiving the induction signal related to cold water;
when the sensing zone for water temperature switching is touched twice by a human body, the touch sensing module may detect a touch signal and output an induction signal related to warm water after processing such touch signal; the control module may open both of the cold water inlet electromagnetic valve and the hot water inlet electromagnetic valve after receiving the induction signal related to warm water;
when the sensing zone for water temperature switching is touched three times by a human body, the touch sensing module may detect a touch signal and output an induction signal related to hot water after processing such touch signal, and then the control module may select to open the hot water inlet electromagnetic valve instead of the cold water inlet electromagnetic valve after receiving the induction signal for selecting hot water.

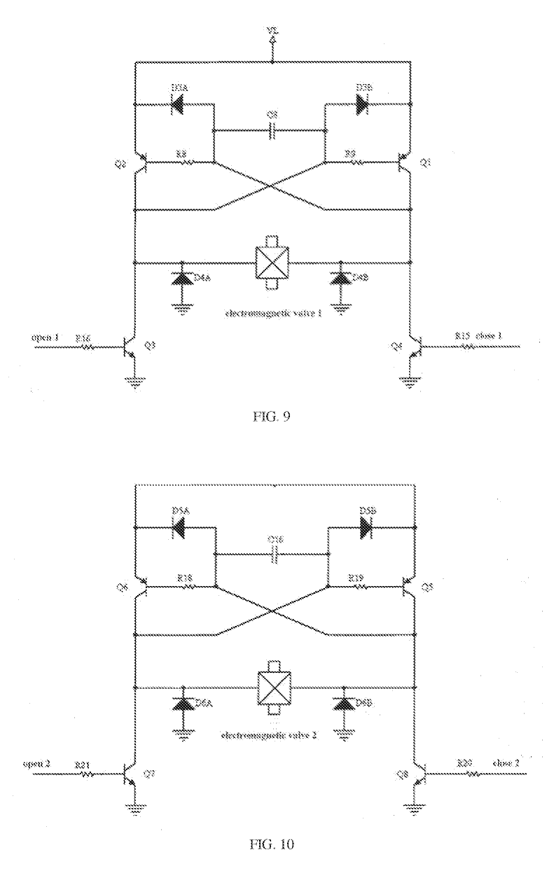

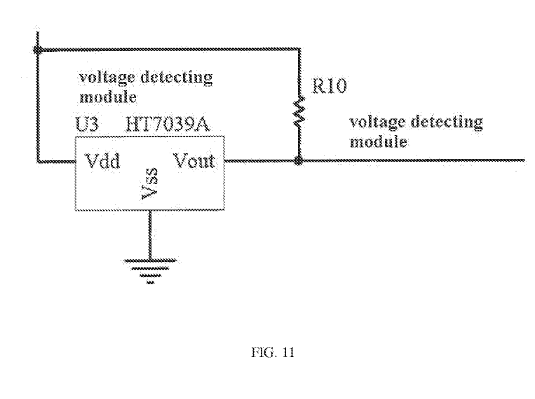

The control module may open the selected inlet electromagnetic valve and supply water based on the choice of a user, wherein, the driving circuit of the inlet electromagnetic valve may consist of four triodes and several resistances, capacitances and diodes, and the principle of the driving circuit is shown in FIG. 9 and FIG. 10.

In this embodiment, an off induction signal for stopping water supply may correspond to the fact that the touch sensing zone for switch control is continuously touched twice. When the touch sensing zone for switch control is touched again by a human body, the touch sensing module may detect a touch signal and output an induction signal for stopping water supply to the control module after processing such touch signal. The control module may close the inlet control valve that is in its open state after receiving the induction signal for stopping water supply, in order to stop supplying water through the outlet of the faucet body.

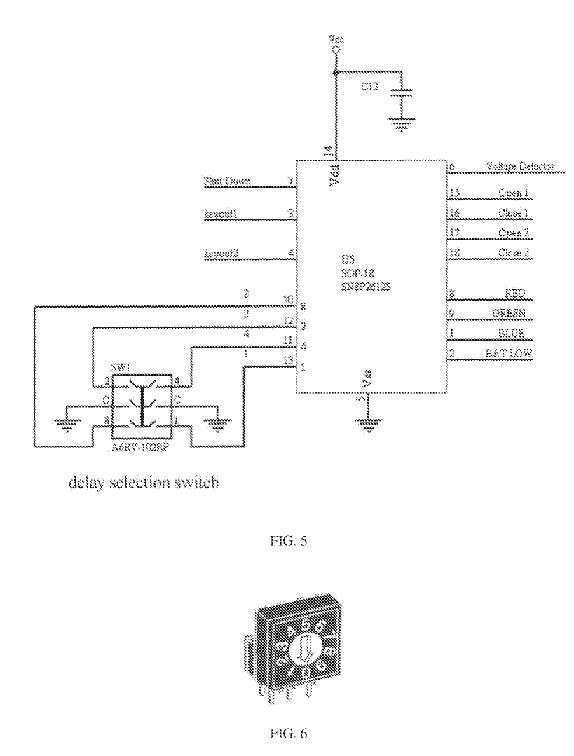

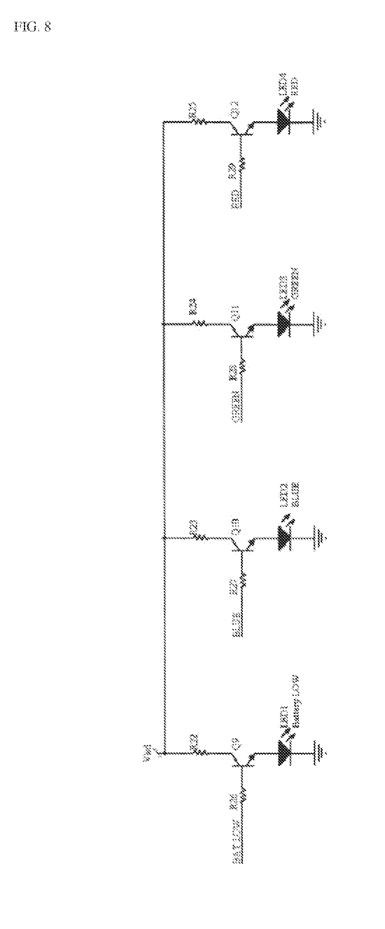

Regarding the above mentioned steps, the schematic diagram of the touch sensing module is shown in FIG. 4, the schematic diagram of the control module is shown in FIG. 5 and the system diagram of the control module is shown in FIG. 7.

### Example 2

Based on the first embodiment, a plurality of water temperature indicating devices may be mounted on the faucet body 100. In this embodiment, the water temperature indicating devices may be indicator lamps. The indicator lamps for indicating water temperature may be respectively in connection with the control module through a connecting line 500, which may be connected to a waterproof plug 501. The control module may activate a corresponding indicator lamp according to the type of water to be supplied selected through the induction signal, in this embodiment, three indicator lamps may be arranged, the first of which is a blue lamp for indicating cold water, the second of which is a green lamp for indicating warm water and the third of which is red lamp for indicating hot water. As shown in FIG. 8, LED2 is the blue indicator lamp, LED3 is the green indicator lamp and LED4 is the red indicator lamp.

In this embodiment, the type of water to be supplied may be selected by touching the sensing zone for water temperature switching, and then the inlet electromagnetic valve may be opened by touching the touch sensing zone for switch control. The control method disclosed in this embodiment comprises:

when the body induction touch control faucet device is in its closed state, if the sensing zone for water temperature switching is touched by a human body, the touch sensing module may detect a touch signal, and output an induction signal related to a type of water to be supplied after processing such touch signal based on the type of water corresponding to the preset times of touching; the type of water may be cold water, warm water or hot water; cold water may be selected if it is touched once, warm water may be selected if it is touched twice, and hot water may be selected if it is touched three times; however, it does not work if the sensing zone is touched more than three times;
when the sensing zone for water temperature switching is touched once by a human body, the touch sensing module may detect a touch signal and output the induction signal related to cold water after processing the touch signal; the control module may receive such induction signal and open the cold water inlet electromagnetic valve instead of the hot water inlet electromagnetic valve, and then activate the blue LED2 for indicating cold water;
when the sensing zone for water temperature switching is touched twice by a human body, the touch sensing module may detect a touch signal and output an induction signal related to warm water after processing such touch signal; the control module may receive the induction signal related to warm water and open both of the cold water inlet electromagnetic valve and the hot water inlet electromagnetic valve, and then activate the green LED3 for indicating warm water;
when the sensing zone for water temperature switching is touched three times by a human body, the touch sensing module may detect a touch signal and output an induction signal related to hot water after processing such touch signal; the control module may receive the induction signal related to hot water and open the hot water inlet electromagnetic valve instead of the cold water inlet electromagnetic valve, and then activate the red LED4 for indicating hot water;
when the LEDS are activated, all of the LEDs may become bright gradually from darkness, which may take 3 s, and then the LEDs may keep bright for another 0.5 s; if no touch signal may be detected within a further 10 s, the LEDs will be inactivated thereafter;
when the touch sensing zone for switch control is touched by a human body, the touch sensing module may detect a touch signal and output an induction signal for supplying water to the control module; after receiving the induction signal for supplying water, the control module may open the inlet electromagnetic valve selected in the above mentioned steps, so as to let water flow into the faucet body through the mixing valve and flow out the outlet of the faucet body;
when the touch sensing zone for switch control is touched again by a human body (for example being continuously touched twice), the touch sensing module may detect the touch signal and output an induction signal for stopping water supply to the control module after processing such touch signal; after receiving the induction signal for stopping water supply, the control module may close the inlet control valve that is in its open state, so as not to let water flow out via the outlet of the faucet body.

### Example 3

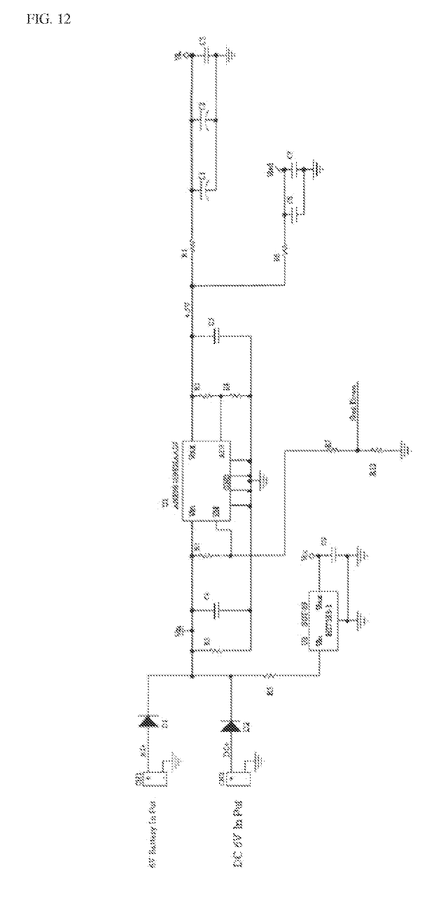

Based on the first and the second embodiment of this invention, the faucet is provided with a voltage detecting module, which is shown in FIG. 11. The voltage detecting module may be in connection with the battery 450 and may be adapted for testing the voltage of the battery. In this embodiment, the voltage detecting module may be Holtek HT7039A chip. A lower voltage alarming device may be arranged on the faucet body, and in this embodiment, the lower voltage alarming device may be an alarm lamp, which may be in connection with the voltage detecting module. If voltage detected by the voltage detecting module is lower than a threshold voltage for alarming, the lower alarm lamp will twinkle, which is shown in FIG. 8 and LED1 is a red lower voltage alarm lamp.

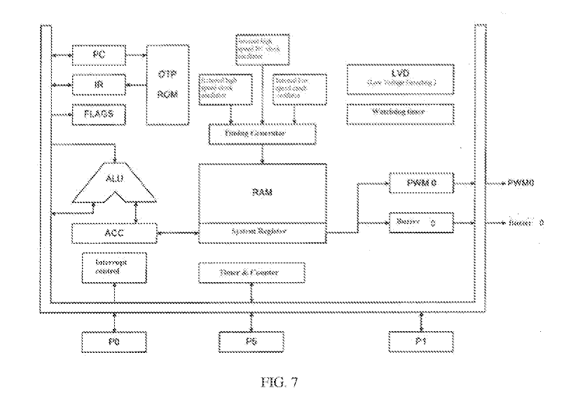

An alternative embodiment of this invention based on the above mentioned embodiments is provided, wherein, a delay selection switch may be further provided, which may be in connection with the control module and adapted for setting outflow time at which water begins to flow out of the faucet body. FIG. 5 and FIG. 6 show that SW1 is the delay selection switch. There are several gears for delay. When the pointer of SW1 indicates 0, the inlet electromagnetic valve may only be closed manually. When the pointer of SW1 indicates 1, there will be an automatic delay of 5 s. When the pointer of SW1 indicates 2, there will be an automatic delay of 10 s. When the pointer of SW1 indicates 3, there will be an automatic delay of 15 s. When the pointer of SW1 indicates 4, there will be an automatic delay of 20 s. When the pointer of SW1 indicates 5, there will be an automatic delay of 30 s. When the pointer of SW1 indicates 6, there will be an automatic delay of 45 s. When the pointer of SW1 indicates 7, there will be an automatic delay of 60 s. When the pointer of SW1 indicates 8, there will be an automatic delay of 90 s. When the pointer of SW1 indicates 9, there will be an automatic delay of 120 s. During the time sequence of delay, people may close the valve manually continuously touching the touch sensing zone for switch control twice.

The control method of this invention may further comprise:

if the voltage of the battery is lower than 3.9V, a low power instruction may be transmitted to the control module by the voltage detecting module; after receiving the low power instruction, the control module may output a twinkle instruction to the lower voltage alarm lamp LED1; the red LED1 may twinkle at a frequency of 1 Hz to give an alarm;
when it is preset that the faucet can be closed through manual touch and automatic delay, which may be selected by SW1; and during the time sequence of delay, people may close the electromagnetic valve through manual touch;
the control module may record the information about the selected water temperature of the last use of the faucet, and may control to supply water at the temperature recorded for the next use; people only need to touch the sensing zone for switch control to open the faucet; when water flows out, the types of water which are defined in terms of temperature of water may be selected by touching the sensing zone for water temperature switching; as mentioned before, cold water will be selected by touching once and a blue LED will be activated, warm water will be selected by touching twice and a green LED (or orange LED) will be activated and hot water will be selected by touching three times and a red LED will be activated.

The faucet device of this invention may further comprise key-locking function. When the touch sensing zone for switch control is pressed for 5 s, the red LED4 will twinkle three times at a frequency of 1 Hz and then it will not work even if any sensing zone is touched; after that, if the touch sensing zone for switch control is pressed for another 5 s, the blue LED2 will twinkle three times at a frequency of 1 Hz and then touching function will be recovered again; in this embodiment, this function may be realized through the control module, which may detect whether the touch sensing zone for switch control is pressed for a certain period of time (such as 5 s); if the touch sensing zone for switch control is pressed for 5 s, the control module may stop outputting control instructions even if it receives a touch signal, after that, it will not work anymore even if any sensing zone is touched, and the key-locking function is realized; if the sensing zone is pressed for a further 5 s, the key-locking function will be cancelled, and the faucet may normally work.

The principle of body capacitance touching sensing of this invention is as follows. Because a human body is equivalent to a capacitance connected to the earth, when a metallic sensing zone, arranged on a right end or a left end of the faucet body, is touched by a human body (such as a finger), a induction capacitance is automatically formed between the earth and the left end or the right end of the faucet body. The capacity of the induction capacitance is usually bellow 100 pF. When the metallic sensing zone on the left end or the right end of the faucet body is touched by a human body, this induction capacitance will be detected by the touch sensing module, and based on the above mentioned principle, the touch sensing module may detect if the metallic sensing zone on the left end or the right end of the faucet body is touched by a human body according to the variation of the capacity of this capacitance.

Although the present invention has been described with particular reference to certain preferred embodiments thereof, variations and modifications of the present invention can be effected within the spirit and scope of the claims.

1. A body induction touch control faucet device, comprising:
a faucet body, provided with an outlet,
a cold water inlet pipe,
a hot water inlet pipe and
a switch unit;
wherein, said cold water inlet pipe and said hot water inlet pipe are in connection with said faucet body through a mixing valve, and said cold water inlet pipe and said hot water inlet pipe are in connection with an inlet of said mixing valve through water inlet electromagnetic valves thereof respectively, and said faucet body is in connection with an outlet of said mixing valve, said faucet device further comprises a sensing zone for switch control and a sensing zone for water temperature switching, arranged on said faucet body, adapted for being touched; and
said switch unit comprises a touch sensing module, which is in connection with said sensing zone for switch control and said sensing zone for water temperature switching respectively, for detecting a touch signal from said sensing zone for switch control and said sensing zone for water temperature switching, and for outputting an induction signal corresponding to a touch behaviour after processing said touch signal;
a control module, in connection with said touch sensing module, adapted to receive said induction signal outputted by said touch sensing module, and to activate said cold water inlet electromagnetic valve and said hot water inlet electromagnetic valve; and
a power module, for supplying power for said touch sensing module and said control module.

2. The faucet device of claim 1, further comprising a plurality of water temperature indicating devices, mounted on said faucet body and in connection with said control module;
wherein, said control module may activate a corresponding water temperature indicating device according to the type of water selected through an induction signal.

3. The faucet device of claim 1, further comprising
a voltage detecting module, in connection with said power module, adapted for detecting voltage of said power module; and
a lower voltage alarming device, arranged on said faucet body and in connection with said voltage detecting module;
wherein, if voltage detected by said voltage detecting module is lower than alarm voltage, said lower voltage alarming device may give an alarm.

4. The faucet device of claim 1, wherein, said faucet body may be made of metal and may be mounted on a faucet base, which comprises a left hollow tube, a right hollow tube and a water outlet tube; said left hollow tube may be said sensing zone for water temperature switching, and said right hollow tube may be said sensing zone for switch control; a lower end of said left hollow tube a lower end of said right hollow tube may be connected with each other through an insulating member, and be further connected with an outlet of said mixing valve through a connecting pipe; an upper end of said left hollow tube and a upper end of said right hollow tube are in connection with said water outlet tube having outlets through an insulating member respectively.

5. The faucet device of claim 4, further comprising
a delay selection switch, in connection with said control module and adapted for setting outflow time of said faucet body for supplying water.

6. The faucet device of claim 1, wherein, said touch sensing module may comprise a human body touch sensing chip.

7. A method for controlling a faucet device of claim 1, comprising steps of:
step 1: when said faucet device is in its closed state and a sensing zone for switch control is touched by a human body, a touch sensing module may detect a touch signal and output an induction signal for supplying water to a control module after processing such touch signal, and said control module may open a water inlet electromagnetic valve after receiving said induction signal for supplying water; and then, water flows into said faucet body through said mixing valve and flows out through said outlet of said faucet body;
step 2: when a sensing zone for water temperature switching is touched by a human body, said touch sensing module may detect a touch signal and select the type of water to be supplied based on preset times of touching correspondingly, and output an induction signal related to a type of water after processing such touch signal; said control module may select and open corresponding water inlet electromagnetic valve to supply water based on the type of water selected after receiving said induction signal related to a type of water;
step 3: when said sensing zone for switch control is touched again by a human body, said touch sensing module may detect a touch signal and process the same into an induction signal for stopping water supply, and then transmit said induction signal for stopping water supply to said control module; said control module may close said inlet control valve that is in its open state after receiving said induction signal for stopping water supply, in order to stop supplying water.

8. A method for controlling a faucet device of claim 1, comprising steps of:
step 1: when said faucet device is in its closed state and a sensing zone for water temperature switching is touched by a human body, a touch sensing module may detect a touch signal and output an induction signal related to a type of water based on preset times of touching correspondingly after processing such touch signal; a control module may select corresponding water inlet electromagnetic valve after receiving said induction signal for supplying water;
step 2: when said sensing zone for switch control is touched by a human body, said touch sensing module may detect a touch signal and output an induction signal for supplying water to a control module; after receiving said induction signal for supplying water, said control module may open said inlet electromagnetic valve selected, so as to let water flow into said faucet body through said mixing valve and flow out through said outlet of said faucet body;
step 3: when said sensing zone for switch control is touched again by a human body, said touch sensing module may detect a touch signal and output an induction signal for stopping water supply to said control module after processing such touch signal; after receiving said induction signal for stopping water supply, said control module may close said inlet control valve that is in its open state, so as to stop supplying water through said outlet of said faucet body.

9. The method of claim 7, wherein, in step 2, said type of water may be cold water, warm water or hot water; cold water may be selected if the sensing zone is touched once, warm water may be selected if the sensing zone is touched twice, and hot water may be selected if the sensing zone is touched three times; but it does not work if the sensing zone is touched more than three times;
when said sensing zone for water temperature switching is touched by a human body once, said touch sensing module may detect a touch signal and output an induction signal related to cold water after processing such touch signal; said control module may receive such induction signal related to cold water and open a cold water inlet electromagnetic valve instead of a hot water inlet electromagnetic valve;
when said sensing zone for water temperature switching is touched twice by a human body, said touch sensing module may detect a touch signal and output an induction signal related to warm water after processing; said control module may receive such induction signal related to warm water and open both of said cold water inlet electromagnetic valve and said hot water inlet electromagnetic valve;
when said sensing zone for water temperature switching is touched three times by a human body, said touch sensing module may detect a touch signal and output an induction signal related to hot water after processing such touch signal; said control module may receive such induction signal related to hot water and open said hot water inlet electromagnetic valve instead of said cold water inlet electromagnetic valve.

10. The method of claim 9, wherein, a plurality of water temperature indicating devices are mounted on said faucet body and in connection with said control module, which is adapted for activating a corresponding water temperature indicating device according to the type of water selected through an induction signal; after receiving said induction signal related to a type of water, said control module may activate a water temperature indicating device corresponding to said type of water.

11. The method of claim 10, wherein, said control module may comprise memory function, adapted for recording the information about said type of water which is selected through said sensing zone for water temperature switching, which allows to supply water with the type recorded for the last use when said sensing zone for switch control is touched next time.

12. The method of claim 11, wherein, said touch sensing module may comprise key-locking and unlocking functions, when key-locking function is activated, any touching on said sensing zone for switch control or said sensing zone for water temperature switching does not work.

13. The method of claim 8, wherein, in step 1 of said claim 8, said type of water may be cold water, warm water or hot water; cold water may be selected if the sensing zone is touched once, warm water may be selected if the sensing zone is touched twice, and hot water may be selected if the sensing zone is touched three times; but it does not work if the sensing zone is touched more than three times;
when said sensing zone for water temperature switching is touched by a human body once, said touch sensing module may detect a touch signal and output an induction signal related to cold water after processing such touch signal; said control module may receive such induction signal related to cold water and open a cold water inlet electromagnetic valve instead of a hot water inlet electromagnetic valve;
when said sensing zone for water temperature switching is touched twice by a human body, said touch sensing module may detect a touch signal and output an induction signal related to warm water after processing; said control module may receive such induction signal related to warm water and open both of said cold water inlet electromagnetic valve and said hot water inlet electromagnetic valve;
when said sensing zone for water temperature switching is touched three times by a human body, said touch sensing module may detect a touch signal and output an induction signal related to hot water after processing such touch signal; said control module may receive such induction signal related to hot water and open said hot water inlet electromagnetic valve instead of said cold water inlet electromagnetic valve.

14. The method of claim 13, wherein, a plurality of water temperature indicating devices are mounted on said faucet body and in connection with said control module, which is adapted for activating a corresponding water temperature indicating device according to the type of water selected through an induction signal; after receiving said induction signal related to a type of water, said control module may activate a water temperature indicating device corresponding to said type of water.

15. The method of claim 14, wherein, said control module may comprise memory function, adapted for recording the information about said type of water which is selected through said sensing zone for water temperature switching, which allows to supply water with the type recorded for the last use when said sensing zone for switch control is touched next time.

16. The method of claim 15, wherein, said touch sensing module may comprise key-locking and unlocking functions, when key-locking function is activated, any touching on said sensing zone for switch control or said sensing zone for water temperature switching does not work.

17. A faucet device of claim 2, wherein, said faucet body may be made of metal and may be mounted on a faucet base, which comprises a left hollow tube, a right hollow tube and a water outlet tube; said left hollow tube may be said sensing zone for water temperature switching, and said right hollow tube may be said sensing zone for switch control; a lower end of said left hollow tube a lower end of said right hollow tube may be connected with each other through an insulating member, and be further connected with an outlet of said mixing valve through a connecting pipe; an upper end of said left hollow tube and a upper end of said right hollow tube are in connection with said water outlet tube having outlets through an insulating member respectively.

18. A faucet device of claim 17, further comprising
a delay selection switch, in connection with said control module and adapted for setting outflow time of said faucet body for supplying water.

19. A faucet device of claim 3, wherein, said faucet body may be made of metal and may be mounted on a faucet base, which comprises a left hollow tube, a right hollow tube and a water outlet tube; said left hollow tube may be said sensing zone for water temperature switching, and said right hollow tube may be said sensing zone for switch control; a lower end of said left hollow tube a lower end of said right hollow tube may be connected with each other through an insulating member, and be further connected with an outlet of said mixing valve through a connecting pipe; an upper end of said left hollow tube and a upper end of said right hollow tube are in connection with said water outlet tube having outlets through an insulating member respectively.

20. A faucet device of claim 5, wherein, said touch sensing module may comprise a human body touch sensing chip.
